(19) United States
(12) Patent Application Publication
(10) Pub. No.: US 2010/0046424 A1
(43) Pub. Date: Feb. 25, 2010

(54) METHOD FOR CONTROLLING LOAD MATCHING IN A RADIO COMMUNICATION SYSTEM

(76) Inventors: Pavol Lunter, Bratislava (SK); Thomas Ulrich, Bad Durkheim (DE); Martin Wolf, Lipfovsky Hradok (SK)

Correspondence Address: STAAS & HALSEY LLP, SUITE 700, 1201 NEW YORK AVENUE, N.W., WASHINGTON, DC, 20005, US

(21) Appl. No.: 12/310,351

(22) PCT Filed: Aug. 21, 2007
(86) PCT No.: PCT/EP2007/058659

§ 371 Date: Aug. 20, 2009

(30) Foreign Application Priority Data
Aug. 23, 2006 (EP) 06017580.9

(51) Int. Cl. H04W 40/00

(52) U.S. Cl. 370/328

(57) ABSTRACT

A method controls transmission of data packets in a radio communication system, with the radio communication system having at least one central node as well as at least one base station connected to it, and with the base station transmitting data packets, which have been received by the central node and have been provided with encryption by the latter, to at least one subscriber terminal via a radio interface. The base station rejects a first number of data packets, before transmission via the radio interface, as a function of the current or expected load state. A respective first information item is added to a second number of data packets to be transmitted to the subscriber terminal, in the central node after encryption, and the base station rejects or does not reject a respective data packet as a function of the first information item.

### CROSS REFERENCE TO RELATED APPLICATIONS

This application is based on and hereby claims priority to PCT Application No. PCT/EP2007/058659 filed on Aug. 21, 2007 and EP Application No. EP06017580 filed on Aug. 23, 2006, the contents of which are hereby incorporated by reference.

### BACKGROUND OF THE INVENTION

The invention relates to a method for controlling load matching in a radio communication system.

Mobile radio systems based, for example, on the GSM standard (Global System for Mobile Communications) or the UMTS standard (Universal Mobile Telecommunication System), whose further developments are being standardized by the so-called 3GPP (3^{rd} Generation Partnership Project) are generally known. As a further development of the UMTS system, work is currently being carried out on the standardization of the so-called UMTS-LTE (LTE: Long Term Evolution) and Evolved-UTRA (UTRA: Universal Terrestrial Radio Access). Some of the important aspects of a long-term development such as this comprise reduced latency, higher subscriber data rates, improved system capacity and system coverage, and reduced costs for the system operator.

In the course of this further development of the UMTS Standard, the structure of the so-called radio access network RAN is also being changed, with the aim of greater flexibility and reduced latency. Base stations, which are referred to as NodeB or NB, as well as eNB in the nomenclature of UMTS LTE, are, in contrast to the current UMTS Standard, responsible for the management and assignment of radio resources at the radio interface to subscriber terminals UE (User Equipment). This function was previously carried out by the so-called radio network controller RNC which now no longer exists as an autonomous component in the RAN.

Other functionalities of the radio network controller are in contrast carried out by a new component, the so-called access gateway aGW. Base stations eNB and the access gateway aGW are connected to one another by a transport network TN in which transmissions take place using, for example, the IP (Internet Protocol). The access gateway aGW is in turn connected to a further IP-based core network. This structure of the radio access system is illustrated by way of example in FIG. 1.

The aim of the further development of the UMTS standard is, furthermore, to largely avoid blocking situations in the individual network components. As a result of the special characteristics of the radio interface, in particular the transmission characteristics which depend on parameters such as time, location, speed of subscriber terminals, load situation in radio cells of adjacent base stations etc., of signals via the radio interface, it is, however, still possible for blocking situations to occur in the base station. By way of example, this may be an overflow of a buffer store in the base station which is allocated to a specific connection or a specific subscriber terminal, for example as a result of an inadequate number of radio resources being available for transmission of data on this connection, or else the need to repeat the transmission of data in accordance with, for example, an ARQ (Automatic Repeat Request) protocol. In this case, the buffer store is used to temporarily store data until it is transmitted via the radio interface.

In situations such as this in which an overflow is imminent or has already occurred in the buffer store allocated to a connection, the base station would, in accordance with the current envisaged procedure, discard data packets which are already located in the buffer store or arrive newly from the aGW, until the overload situation no longer exists. However, this has the disadvantage that it ignores the fact that the base station generally has no knowledge of the content of the data packet or its importance, since data packets are encrypted (ciphered) between the aGW and the subscriber terminal, and so-called header compression is provided, for example based on the so-called ROHC (Robust Header Compression). The base station, which cannot decrypt the encrypted and compressed data packets, will therefore potentially also discard data packets which are required for reliable decryption and back-conversion of the data in the subscriber terminal. This can disadvantageously lead to adverse effects, which are clearly perceptible for the subscriber, in the connection quality, and can possibly lead to a breakdown of the connection. In particular, a connection breakdown can occur in this case if the encryption mechanisms in the aGW and the subscriber terminal are no longer synchronized and there is also no longer any capability at the subscriber terminal to recreate this synchronicity.

In order to avoid situations such as this, the responsibility for avoidance of overload situations may be extended, for example, from just the base station on its own to the aGW. This would require matching between the base station and the aGW which, in the event of an overflow of the buffer store in the base station, for example, would not send any more data packets received from other system components on the connection to the base station until the overload situation there had been rectified. Storage of data packets such as these in the aGW would accordingly be necessary. However, this solution is contradictory to the fact that, on the basis of the current proposals, the aGW is not intended to be equipped with buffer stores, and is therefore not equipped for supplementary temporary storage of data packets.

### SUMMARY

One potential object of the invention is therefore to specify a method and components of a radio communication system which allow efficient avoidance of critical situations, which occur as a result of discarding of data packets, taking account of the system structure described above.

The inventors propose a radio communication system which has at least one central node and at least one base station which is connected to it. Encrypted data packets received from the central node are transmitted by the base station to at least one subscriber terminal via a radio interface, with a first number of data packets being discarded, before transmission via the radio interface, by the base station depending on a current or expected load state. Characteristically, the central node adds a respective first information item to a second number of the data packets to be transmitted after encryption to the subscriber terminal. This first information item is used by the base station to decide whether a respective data packet is or is not discarded.

This advantageously ensures that only encrypted data packets which have no importance or have minor importance for maintenance of the connection are discarded by the base station in the event of an overload as described above. Since the central node is aware of the respective content of the data packets, since this is freely accessible to the subscriber terminal before the encryption for transmission, it can determine the respective relevance of the data packets for the connection and can add the first information item as appropriate. In contrast to the encrypted content of the data packets, the added first information item can be evaluated by the base station and can be used as the basis for the decision as to whether a data packet will or will not be discarded in the event of an overload as in this example. The second number of the data packets which are provided with the first information item by the central node is preferably chosen to be greater than the first number of data packets that are in the end discarded by the base station. The base station can therefore discard data packets individually, matched to the respective load situation.

The first information item, which is added to the second number of data packets, may, for example, be a state bit (flag) in the header field of a so-called packet data unit (PDU) which is carrying the encrypted data packet.

According to one development of the proposal, the first information item is added only to encrypted data packets which can subsequently be discarded by the base station. This can be implemented, for example, in such a way that the state bit is set and is transmitted to the base station as well only when it indicates that the data packet can be discarded. As an alternative refinement to addition of a state bit to all data packets and distinguishing on the basis of the state of the bit, (for example a binary value, where 0 represents cannot be discarded and 1 represents can be discarded), this advantageously reduces the signaling load on the interface between the central node and the base station.

According to a further development, the base station signals to the central node a second information item relating to the current or expected load state. By this second information item, which is preferably signalled to the central node periodically or depending on specific circumstances, for example overshooting of one or more threshold values as a measure of the filling level of the buffer store in the base station, the central node is advantageously aware of the load state in the base station.

According to a further development, which is based on this, the central node controls the addition of the first information item to the encrypted data packets depending on the received second information item. This can be done, for example, by matching the number of the data packets which are provided with a state bit which indicates possible discarding to the current overload situation, that is to say the central node provides at least a sufficient number of data packets with a state bit such as this (if possible) that the overload on the buffer store in the base station can be dissipated within a specific time period by the base station.

According to a further development based on this, the central node additionally discards a third number of data packets even before transmission to the base station. This is advantageous in particular when the central node can already estimate the number of data packets which will be discarded by the base station, on the basis of the signal of the load situation and in addition with knowledge, for example, of the rate at which new data packets are being received. This allows the load on the base station to be reduced by the central node discarding a specific third number of data packets, in which case there is also an obligation on the base station to discard a corresponding first number of data packets in order to reduce the overload.

According to a further development based on this, the central node selects a ratio of the third number to the second number of data packets depending on the signalled second information item. As described above, this allows the central node to optimally match the load situation in the base station.

The inventors also propose a radio communication system, and components of a system such as this, each have units which they can use to implement the method features.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an exemplary structure of the radio communication system, including two flowcharts,

FIG. 2 shows a diagram with state transitions in components of the radio communication system,

FIG. 3 shows an exemplary timing diagram of the proposed method,

FIG. 4 shows a further diagram with state transitions in components of the radio communication system,

FIG. 5 shows a further exemplary timing diagram, and

FIG. 6 shows indications of the bit rates at the respective interfaces between the components of the radio communication system.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

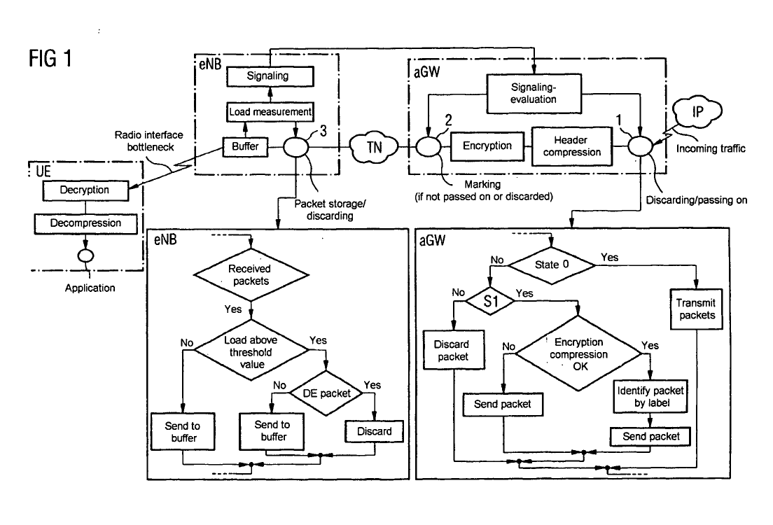

FIG. 1 shows, by way of example, the structure of a radio communication system, in particular based on the current state of the UMTS-LTE standardization. A so-called access gateway aGW is connected to further components of the system or other systems via an IP-based network. The aGW receives incoming data traffic from this network IP, in the form of data packets. These incoming data packets are processed further in the aGW, as will be described in detail in the following text. The aGW is also connected to at least one base station eNB via a transport network TN. The base station eNB, which is illustrated by way of example, is in turn connected to a subscriber terminal UE via a radio interface which is considered to be the entity which limits the data rate and is therefore critical (bottleneck).

It is assumed that a communication link on which, at least, data packets are transmitted to the illustrated subscriber terminal UE exists between a source of data packets which is not illustrated, for example a further subscriber terminal or a server, and the illustrated subscriber terminal UE. These data packets serve an application, for example a so-called video streaming application, in the subscriber terminal UE.

On this link, aGW therefore receives data packets for the subscriber terminal UE, which it passes on to the base station eNB in whose radio coverage area or radio cell the subscriber terminal UE is currently located. In accordance with a test in a first step 1, which will be described in more detail in the following text, the aGW first of all carries out compression (header compression) of the header field of the data packets and of the packet data units (PDU) which transport the data packets, as well as encryption (ciphering) of the data packets. This compression and encryption exist between the aGW and the subscriber terminal UE, and in a corresponding manner the subscriber terminal UE has a decryption unit for decryption (deciphering) and decompression of the received data packets. In accordance with a second step 2, which will likewise be described in more detail in the following text, the aGW transmits the data packets via the transport network TN to the base station eNB. In the base station eNB, the compressed and encrypted data packets are temporarily stored in a buffer store (buffer) in accordance with a third step 3, which will be explained in the following text, before they are transmitted via the radio interface to the subscriber terminal UE using radio resources assigned by the base station eNB. The buffer store (buffer) or a specific area of a central buffer store in the base station eNB is allocated to the connection and, for example, is dimensioned depending on the expected data rate or a quality of service.

As described initially, the base station eNB which receives the data packets from the aGW via the transport network TN therefore has no facilities for decompression and decrypting of the data packets so that it also cannot deduce a potential capability to discard data packets in the event of overloading on the basis of the content of the data packets or specific parameters, which are located in the compressed header field for example, such as details relating to the quality of service requirements or the like. The base station eNB would therefore avoid overloading, which are not illustrated, to discard data packets before transmission to the subscriber terminal UE or even before storage in the buffer store, with the disadvantageous consequences, as mentioned initially, for example of a connection breakdown as a result of data packets which are required to maintain the connection being discarded.

The first proposed method relates to the steps 2 and 3 illustrated in FIG. 1. According to step 2, the data packets are marked (marking) in the aGW after compression of the header field (header compression) and encryption (ciphering). Since this marking is carried out after compression and encryption, the base station eNB can evaluate this information. By way of example, the data packets are marked by a state bit which indicates the capability to discard the respective data packet. This state bit is also referred to in the following text as the discard eligibility (DE) bit. The state bit can be advantageously set or added by the aGW since the aGW can access the complete data set of the data packets and is therefore advantageously able to determine or to estimate the relevance for maintenance of the link. In a corresponding manner, the aGW uses the state bit to indicate to the base station eNB which data packet may be discarded by it when discarding is necessary because of overloading. If the state bit has binary values, a binary 0 may in this case represent not discardable and a binary 1 discardable. Alternatively, however, the state bit can also be transmitted only when the data packet can be discarded. This advantageously makes it possible to reduce the signaling load on the interface between the aGW and the base station eNB.

In the third step 3, as indicated below the base station eNB in the flowchart, after reception of a data packet from the aGW, a decision is made in the base station eNB as to whether the received data packet will be stored (packet store) in the buffer store (buffer) for transmission via the radio interface or will be discarded. A decision diagram relating to this decision process is also additionally indicated in the third step 3. After reception of one or more data packets (packets received), a check is first of all carried out to determine whether a current load, or a load which is to be expected with regard to the data packet or packets received, on the buffer store (buffer), which is determined in the base station eNB (load measurement) is compared with a predetermined threshold value. The definition of the threshold value or of a plurality of threshold values will be explained in more detail in the following text with reference to the further figures. If the current or expected load does not (No) exceed the threshold value, then the data packet is passed onto the buffer store (move to buffer). If, in contrast, the load has already exceeded (Yes) the threshold value, then a check is then carried out to determine whether this is a data packet provided with a set state bit (DE packet). If this is not the case (No), that is to say the data packet must not be discarded by the base station eNB, then it is once again passed onto the buffer store (move to buffer). If, in contrast, it is a data packet provided with the state bit (Yes), then it is discarded by the base station eNB in order to reduce or to overcome the overload in the buffer store.

In addition to these mechanisms, signaling can be derived in the base station eNB from the measurements of the load (load measurement) of the buffer store, and is transmitted to the aGW. This signaling may, for example, be in the form of a so-called overload indicator, referred to in the following text as a buffer overflow prediction (BOP) indicator. This indicator (BOP) is, for example, signalled to the aGW when a specific threshold value of the buffer store has been exceeded, thus making it possible to predict a potential overload of the buffer store. When defining the threshold value, it should be remembered in this case that the consequences of the signaling are detectable at the base station eNB only after a specific time period has passed. For example, the threshold value can be defined using the following formula:

TL [packets]≦TBS (packets]−TBR [packet/s]*RTT[s], with
TL=threshold value (Threshold Level)
TBS=total size of the buffer store (Total Buffer Size)
TBR=Transmission bit rate, that is to say the rate at which data is transmitted between the aGW and the base station eNB (Transmitted Bit Rate)
RTT=time for forward and return transmission (Round Trip Time),
where RTT=2*OTT, where
OTT=single transmission time (One Trip Time), and
s=second.

The threshold value TL is therefore set such that no overflowing of the buffer store as a result of an excessive number of incoming data packets can occur before the signaling becomes effective after the time period RTT.

The indicator is preferably signalled from the base station eNB to the aGW only when an overload situation exists or can be predicted. Particularly when there are a large number of links which are being dealt with in the same manner in parallel, this advantageously reduces the signaling load between the two components. However, alternatively, the load situation can be signalled periodically in the same manner, as a result of which the aGW is periodically made aware of the current load situation in the base station eNB, in which case, for example, the indicator may assume a plurality of state levels. State levels such as these may, for example, be indicators of overload/no overload and/or overshooting/undershooting of the threshold value x,y,z.

After reception and evaluation (signaling evaluation) of the indicator, the aGW then starts the marking of encrypted data packets by state bits, in accordance with the above description in the second step 2.

As an alternative to or in addition to the marking of data packets which can potentially be discarded in step 2, the aGW can also itself discard data packets in step 1. This can once again be controlled as a function of the signalled indicator or state. The discarding of data packets in the aGW itself advantageously in its own way reduces the load on the interface between the aGW and the base station eNB, that is to say the base station eNB in general has to deal with a smaller number of data packets on the link. Furthermore, the stability of the link itself is not adversely affected since, for example, the numbering of the data packets is added only in conjunction with the compression of the header field and the encryption of the data packets and is therefore retained until reception by the subscriber terminal UE, except for possibly further marked data packets which are discarded by the base station eNB. However, discarding of data packets in the aGW itself may possibly disadvantageously act counter to a current load situation. As described above, a delay in the order magnitude of RTT exists before the discarding in the aGW has any effects on the load state in the base station eNB. However, the load situation in the base station eNB may have already changed within this time period in such a way that, for example, as a result of short-term use of further transmission resources on the radio interface, it would no longer be necessary to discard data packets on the basis of the load state in that situation. In this case, data packets would therefore be discarded by the aGW which could have been transmitted without any problems to the subscriber terminal UE using the available resources. By way of example, this may have a disadvantageous influence on the quality of service (QoS) of the link. If the decision as to whether a data packet is discarded or not is in contrast made in the base station eNB, then it is possible to decide directly, that is to say with approximately no delay and depending on a current load situation, whether and what number of data packets need be discarded in order to prevent overloading of the buffer store.

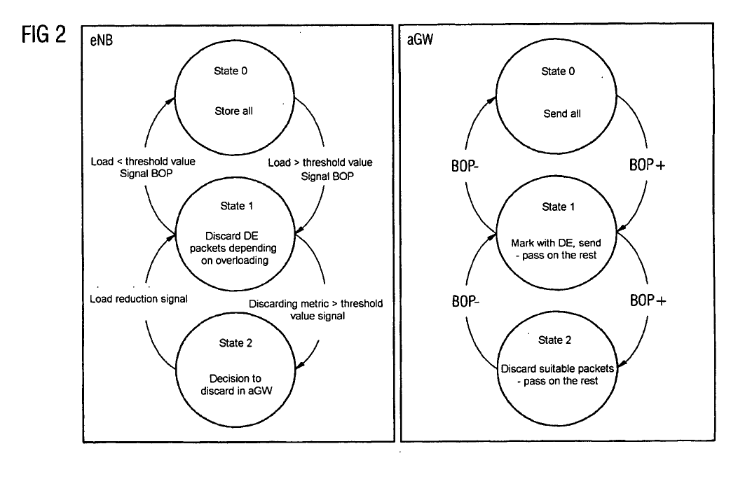

A further flowchart with the individual steps and decisions in the first step 1 is illustrated by way of example below the illustration of the aGW in FIG. 1. In this case, reference is also made to different state levels of the aGW, which will be explained in more detail in conjunction with FIG. 2.

First of all, when a data packet is received from the IP network, a check is carried out to determine whether the aGW is in the state 0. If this is the case (Yes), then the data packet is passed on for subsequent compression of the header field and encryption. If, in contrast, the aGW is not in the state 0 (No), then a check is carried out to determine whether it is in the state 1 (s1). If this is not the case (No), then the aGW is in a state 3, on the basis of which specific data packets or a specific number of data packets will have already been discarded in the aGW (discard packet). If, in contrast, the aGW is in state 1 (s1), then a check is carried out to determine whether the data packet can be discarded after encryption (ciphering) and compression (OK). If the data packet cannot potentially be discarded (No) by the base station eNB, since for example it is of major importance for maintenance of the link, then it is transmitted without any supplementary marking to the base station eNB (send packet). If, in contrast, it can be discarded on the basis of the check (Yes), it is marked after compression of the header field and encryption (label packet), that is to say the state bit is added, and only then is it transmitted to the base station eNB (send packet).

FIG. 2 shows diagrams for the base station eNB and for the aGW, illustrating the individual state transitions and state levels by way of example. The left-hand diagram relating to the base station eNB in this case relates to the determination of the load situation and generation, derived therefrom, of signaling, while the right-hand diagram indicates the reactions of the aGW to this signalling from the base station eNB. First of all, it is assumed that both the base station eNB and the aGW are each in state 0, that is to say the base station eNB is able to store all the data packets received from the aGW in the buffer store (store all) without this resulting in any predictable overload of the buffer store, and the aGW passes on all the data packets received from the IP network via the transport network TN to the base station eNB without any action according to the proposed method.

If the base station eNB now determines that the current load on the buffer store exceeds a threshold value (load>threshold), then it uses an indicator (signal BOP+), for example a state bit with a binary value 1, to signal to the aGW, indicating the need for a state change both of the base station eNB and of the aGW to state 1. After reception of the indicator (BOP+), the aGW correspondingly changes to state 1 and starts to add state bits to a plurality of data packets which can be discarded, and to transmit these marked data packets to the base station eNB (mark with DE, send), and to transmit data packets which cannot be discarded (forward the rest) corresponding to the above description relating to the FIG. 1. A corresponding state change to state 1 is also carried out by the base station eNB, which discards data packets provided with the state bit, depending on the current or expected overload or blocking (discard DE packets according to the congestion).

If it is possible just by these mechanisms for the load on the buffer store to fall below the threshold value again (load<threshold) after a specific time period, for example, then the base station eNB uses the indicator (signal BOP−), this time for example by the binary value 0 of the state bit, to signal to the aGW that a state change can be made back to the original state, state 0. In a corresponding manner, after reception and evaluation of the signaling (BOP−), the aGW carries out this state change to the state 0.

If, in contrast, the load on the buffer store is still above the threshold value (discard metric>threshold) after the specific time period, then the base station eNB on this occasion uses the indictor (signal BOP+) to signal to the aGW, for example once again by the state bit with a binary value 1, that a further state change is required to state 2. After reception of this new indicator (BOP+), the aGW correspondingly changes to state 2 and, in a corresponding manner to the above description relating to FIG. 1, starts to discard a plurality of data packets which have been identified as discardable (discard appropriate packets, forward the rest) even before transmission to the base station eNB and passing on to the base station eNB data packets which are not suitable for discarding. The aim of this measure in the aGW is to make it possible for the base station eNB, which is likewise in state 2, to once again be able to store all the data packets received from the aGW (store all, discarded in the aGW).

If there is a trend to, or there actually is, a decrease in the load (load decreasing) in this sequence in the base station eNB to a level which can in fact be dealt with by state 1 measures, then the base station eNB signals to the aGW by the indicator (signal BOP−), for example once again by the state bit with a binary value 0, a state change from state 2 back to state 1. After reception and evaluation of this indicator (BOP−), the aGW correspondingly changes back to state 1. For subsequent state change back to state 0, reference should be made to the above description.

According to one alternative, which is not illustrated, state 2 may, for example, also contain state 1 measures. This would mean that only a specific number of data packets which can potentially be discarded would actually be discarded in the aGW while, in contrast, the remaining number of data packets which can potentially be discarded are marked, corresponding to the method in state 1, with a state bit for discarding by the base station eNB. The base station eNB would also discard supplementary data packets in state 2, depending on the current load situation. This advantageously ensures that only a total number of data packets as required to prevent overloading of the buffer store are discarded. The change of the aGW from state 1 to state 2 could in this case also be carried out independently of new signaling of an indicator by the base station eNB. For example, after a predetermined time interval in which the aGW was in state 1, a change is automatically made to state 2 which, for example, is likewise maintained for a specific time period before once again automatically changing back to state 1. In this case, in the event of an automatic change of the aGW to state 2, the base station eNB would not likewise need to change to state 2, but could in fact continue to operate on the basis of the state 1 mechanisms. Signaling of an indicator (BOP−) would result in the aGW which is in state 2 changing back directly to the original state 0.

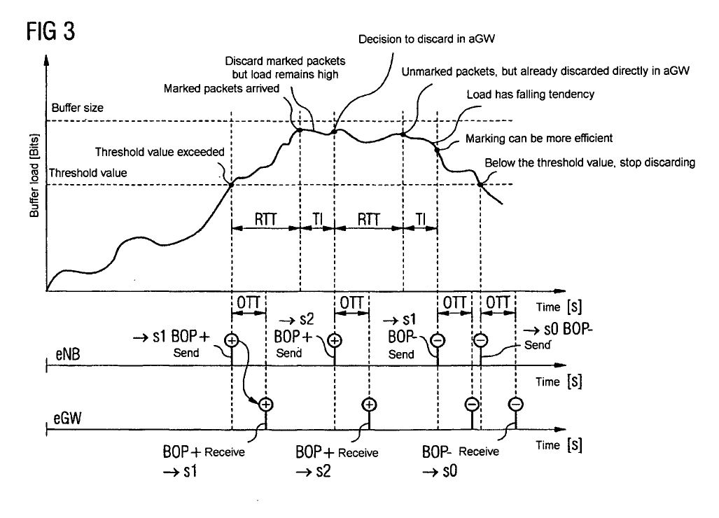

With reference to the above explanations relating to FIG. 1 and FIG. 2, FIG. 3 shows an example of a timing diagram illustrating the relationships between and effects of the individual signaling, state changes and methods relating thereto. The diagram illustrates the load on the buffer store (Buffer Load [bits]) in the base station eNB plotted against the time (Time [s]) by a solid line. In addition, a first horizontal dashed line defines a size of the buffer store (buffer size) and a second dashed line parallel to this defines a predetermined threshold value (Threshold). Furthermore, the respective state transitions in the base station eNB and in the aGW are also additionally illustrated on the lower time axes.

Since the load on the buffer store is initially below the threshold value, the fluctuations in the load are caused by variable transmissions on the radio interface to the subscriber terminal UE, and both the base station eNB and the aGW are in state 0. If, for example, as a result of deteriorating transmission characteristics of the radio interface, the load on the buffer store now exceeds the predetermined threshold value (Threshold crossed) and at a point in time, then the base station eNB changes to state 1 (→s1) and signals to the aGW an indicator to change to the next higher state (Send BOP+). After a single delay time OTT of the signal, the aGW receives the indicator (Receive BOP+) and likewise changes to state 1 (→s1). In a corresponding manner to the above description, after changing to state 1, the aGW starts to mark data packets which can be discarded, before a transmission to the base station eNB. These marked data packets are received for the first time by the base station eNB (Marked packets arrived) after a double delay time RTT (including a processing time in the aGW), in which case the load on the buffer store, for example, rises further during the time period RTT. The base station eNB now starts to discard marked data packets in order to reduce the load on the buffer store.

If, as illustrated, the load on the buffer store still remains above the threshold value throughout a predetermined time interval TI despite the measures in the base station eNB (Marked packets discarded, but load keeps high), then the base station eNB decides (Decision to discard in the aGW) in a next step to carry out a further state change to state 2 (→s2). The base station eNB signals this to the aGW once again by an indicator to change to the next higher state (Send BOP+). After a single delay time OTT once again, this indicator is received by the aGW (Receive BOP+) and is evaluated, and a corresponding state change (→s2) is carried out to state 2. Following the change to state 2, the aGW starts to discard a plurality of data packets even before they are passed on to the base station.

This discarding of data packets in the aGW itself and the reception associated with this of data packets which are marked as not for potential discarding can be detected by the base station eNB after the delay time RTT (unmarked packets, but discarded already in the aGW). As a result of discarding in the aGW, the load on the buffer store as shown in the illustrated example has a downward trend (load has decreasing tendency). Once this is once again the case after a predetermined time interval TI, the base station eNB decides to change back to state 1, whose measures subsequently promise greater efficiency of the discarding of data packets (marking may be more efficient). The base station eNB then carries out a corresponding state change (→s1) back to state 1, and signals this by an indicator (Send BOP−) to the aGW. After the delay time OTT, in which the aGW is still discarding data packets, the aGW receives the indicator and likewise carries out a state change back to state 1.

On the basis of the example in FIG. 3, a short time after reception of the indicator by the aGW, the load on the buffer store undershoots the threshold value (below the threshold—stop discarding). This undershooting causes the base station eNB to carry out a further state change back to state 0 (→s0), and to signal this by an indicator to the aGW (send BOP−). After the delay time OTT has passed again, the aGW receives the signaling (Receive BOP−) and, as a consequence of this, likewise carries out a state change back to state 0 (→s0).

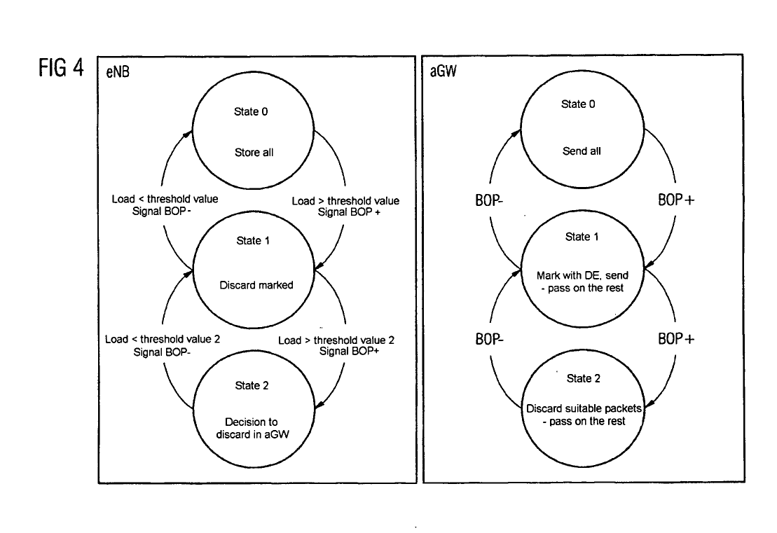

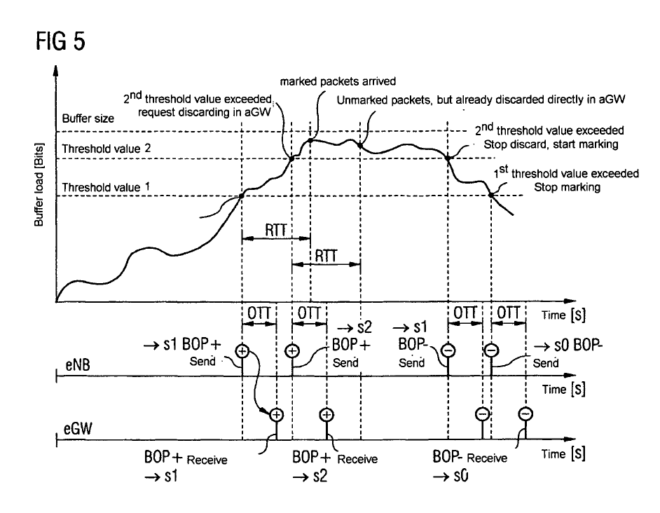

FIGS. 4 and 5 illustrate modifications to the examples in FIGS. 2 and 3. In contrast to the definition of a single threshold value (threshold) and a time interval (TI) in FIGS. 2 and 3, whose overshooting or undershooting or state during or after this has elapsed resulted in a state change, the state changes are carried out depending on two defined threshold values.

While the state transition in FIG. 4 from state 0 to state 1 and back is identical both in the base station eNB and in the aGW with the state transition in FIG. 2, that is to say it takes place after a first threshold value is overshot or undershot, a state transition according to FIG. 4 from state 1 to state 2 is initiated in the base station eNB only after overshooting a second threshold value (load>threshold 2), and back from state 2 to state 1 only after undershooting the second threshold value (load<threshold 2).

The consequences of this modified state transition are illustrated by way of example in FIG. 5. The second exemplary threshold value (Threshold 2) is illustrated as a horizontal dashed line above the line of the first threshold value (threshold 1) in FIG. 5. The initial situation is once again state 0, both in the base station eNB and in the aGW.

Once the specific load on the buffer store in the base station eNB has exceeded the first threshold value (1^{st} threshold crossed), the base station eNB carries out a state change to state 1 (→s1) and signals this by an indicator to the aGW (Send BOP+). After the delay time OTT, the aGW receives the signaling (Receive BOP+) and likewise carries out a state change to state 1 (→s1). Even before the effect of the state change, that is to say the marking of data packets which can be discarded by the aGW, can be detected by the base station eNB after a time period RTT (marked packets arrived), the load, on the basis of the example shown in FIG. 5, will have already exceeded the second threshold value (2nd threshold crossed), however. This causes the base station eNB to request that data packets actually be discarded in the aGW (request discarding in the aGW). This is done by a state change from the existing state 1 to the state 2 (→s2) and by signaling to the aGW by an indicator (Send BOP+). This receives the signaling (Receive BOP+) after the delay time OTT and carries out a corresponding state change to state 2 (→s2). As a consequence of this state change, the aGW starts to discard data packets even before they are passed on to the base station eNB. This measure can once again be detected by the base station eNB only after the time period RTT, that is to say only after this time period does the base station eNB once again receive unmarked data packets from the aGW (unmarked packets, but discarded already in the aGW). During this time period, that is to say until reception of the first data packets which are not marked for potential discarding, the base station eNB can itself if necessary discard already stored marked data packets and those which are still arriving, corresponding to state 1, in order to reduce the load in the buffer store.

As shown in the example in FIG. 5, the load on the buffer store is reduced in particular as a result of data packets being discarded in the aGW itself, until this load once again undershoots the second threshold value after an undefined time (2^{nd} threshold crossed). This leads to a decision in the base station eNB to cancel the discarding in the aGW again and once again to allow these data packets to be marked by the base station eNB for potential discarding. This decision is implemented in the base station eNB by a state change from the current state 2 back to state 1 (→s1) and a corresponding signaling of an indicator to the aGW (Send BOP−). After a delay time OTT, this signaling is received by the aGW, and a state change is made back to state 1 in the aGW.

During the delay time OTT prior to reception of the signaling, the aGW continues to discard data packets, as a result of which, according to the example in FIG. 5, this leads to a further reduction in the load on the buffer store. After an undefined time, this load also undershoots the first threshold value (1st threshold crossed), which leads to the decision in the base station eNB to carry out a state change back to state 0, with corresponding ending of the marking of data packets which can potentially be discarded, by the aGW (stop marking). The base station eNB implements this decision by a state change to the state 0 (→s0) and signals this state change by an indicator to the aGW (Send BOP−), which likewise carries out a state change to state 0 (→s0) after reception of the signaling (Receive BOP−) and evaluation.

In addition to a definition of two threshold values according to the example in FIGS. 4 and 5, it is also possible to define a greater number of threshold values. When respectively overshot or undershot, for example, these define a ratio of data packets which have already been discarded in the aGW and data packets marked for potential discarding. For example, if a first, lower threshold value were to be overshot, 100% of the data packets which could potentially be discarded could initially be marked, while only 80% could still be marked when a second threshold value is overshot, with the remaining 20%, in contrast, having already been discarded in the aGW. When a third threshold value is overshot, this ratio can then be changed to 60%/40%, etc.

All of the threshold values may, of course, also be provided with hysteresis, which can advantageously prevent continual state changes in the situation in which the load is fluctuating in the region of a threshold value. Dimensioning of such hysteresis and definition of the threshold values themselves require the knowledge of a relevant person skilled in the art, for example based on statistical analyses of the system behavior.

A decision on the number of data packets which must be discarded even in the aGW in order to prevent overloading of the buffer store in the base station eNB can alternatively also be made in the aGW itself. Let us assume that the base station eNB in the example shown in FIG. 1 is able, after and during the overshooting of the threshold value, and for example with knowledge of the transmission characteristics of the radio interface, to determine the data rate at which data packets can be transmitted to the subscriber terminal UE. This determined data rate can then be signalled from the base station eNB to the aGW, for example by a plurality of indicators for specific discrete values or by an absolute value. On the basis of this information about the data rate that is supported on the link and with knowledge of the data rate of the data packets received from the IP network on the link, the aGW calculates what number of data packets must be discarded and/or the data rate at which data packets can be transmitted to the base station eNB in order to achieve the data rate which is currently supported by the base station eNB but without this resulting in an overload of the buffer store, and with the aim of bringing the load below the threshold value again.

The data rate on the interface (S1) between the aGW and the base station eNB is calculated, for example, using the following formula:

TBR(n)=MBR(n)+MinBR=ABR(n−1), where
MinBR—a minimum date rate on the radio interface which, for example, can be determined on the basis of statistics relating to the transmission characteristics,
ABR—a currently available data rate on the radio interface (Available Bit Rate) where ABR≧MinBR,
TBR—Transmission data rate on the interface (s1) between aGW and base station eNB (Transmitted Bit Rate)
MBR—rate at which data packets are marked by the aGW (Mark Bit Rate)
IBR—incoming data rate from the IP network (Incoming Bit Rate)
n—number of data packets.

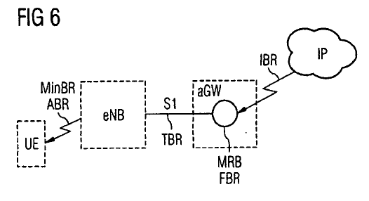

By way of example, these data rates are associated with the components and interfaces in FIG. 6.

In the event of blocking, MBR should be calculated as follows:

MBR(n)=ABR(n−1)−MinBR

Data packets are therefore transmitted from the aGW to the base station eNB at the data rate TBR, and data packets beyond this are in contrast discarded in the aGW itself. Furthermore, data packets up to the data rate ABR are marked for potential discarding as a result of which, if required, they can additionally be discarded by the base station eNB, for example if the currently available data rate on the radio interface ABR is less than the data rate signalled to the aGW. In addition, if the aGW has not received any more details about the currently available data rate from the base station eNB within a specific time period, for example, the aGW can assume that the overloading or the blocking has ended and can end the automatic discarding of data packets in the aGW and, possibly in addition, the marking of data packets which can potentially be discarded.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-13. (canceled)

14. A method of controlling transmission of data packets in a radio communication system having at least one central node, at least one base station connected to the at least one central node, and at least one subscriber terminal communicating with the at least one base station via a radio interface, comprising:
adding a first information item at the at least one central node to each of a first number of data packets to be transmitted to the base station, the data packets having been encrypted by the at least one central node, and transmitting the encrypted data packets to the at least one base station;
discarding a second number of the data packets received from the at least one central node at the at least one base station depending on a current or expected load state, the at least one base station discarding or not discarding respective data packets based on the first information items added to the respective data packets; and
transmitting remaining data packets from the at least one base station to the at least one subscriber terminal via the radio interface after the second number of the data packets have been discarded.

15. The method as claimed in claim 14, wherein the at least one base station transmits a second information item relating to the current or expected load state to the at least one central node.

16. The method as claimed in claim 15, wherein the at least one central node adds the first information items to the first number of encrypted data packets based on the second information item relating to the load state.

17. The method as claimed in claim 15, wherein the at least one central node discards a third number of the data packets to be transmitted to the subscriber terminal, before transmitting the encrypted data packets to the base station based on the second information item relating to the load state.

18. The method as claimed in claim 17, wherein the at least one central node selects a ratio of the third number of the data packets to the first number of the data packets based on the second information item.

19. The method as claimed in claim 14, wherein the current or expected load state is determined depending on a state of a memory providing temporary storage of the encrypted data packets.

20. The method as claimed in claim 14, wherein the at least one central node adds the first information item only to each of data packets that can be discarded by the base station.

21. A radio communication system, comprising:
at least one subscriber terminal;
at least one central node having an encryption unit encrypting data packets to be received at the at least one subscriber terminal, an adder unit adding a first information item to each of a first number of the encrypted data packets and a transmitter transmitting the encrypted data packets; and
at least one base station having a receiver receiving the encrypted data packets transmitted from the at least one central node, a discarding unit discarding a second number of the encrypted data packets depending on a current or expected load state and a transmitter transmitting remaining encrypted data packets to the at least one subscriber terminal via a radio interface, the at least one base station discarding or not discarding respective data packets based on the first information items added to the respective data packets.

22. The radio communication system as claimed in claim 21, wherein the at least one base station has a signaling unit signaling a second information item relating to the current or expected load state to the at least one central node.

23. A node in a radio communication system, comprising:
an encryption unit encrypting data packets to be received at at least one subscriber terminal;
a transmitter transmitting the encrypted data packets to at least one base station in the radio communication system; and
an adder unit adding a first information item to each of a first number of the encrypted data packets to be transmitted to the at least one subscriber terminal, the at least one base station discarding a second number of data packets based on the first information items added to the respective data packets.

24. The node as claimed in claim 23, further comprising a discarding unit discarding a third number of data packets depending on a second information item received from the at least one base station that relates to a current or expected load state in the at least one base station.

25. A base station in a radio communication system, comprising:
a receiver receiving encrypted data packets from a central node in the radio communication system;
an evaluation unit evaluating a first information item added by the central node to each of a first number of encrypted data packets
a discarding unit discarding a second number of encrypted data packets based on the first information items added to the respective data packets; and
a transmitter transmitting the remaining encrypted data packets after the second number of data packets have been discarded to at least one subscriber terminal via a radio interface.

26. The base station as claimed in claim 25, further comprising a buffer storing the encrypted data packets received from the central node.
